(19) United States
(12) Patent Application Publication
(10) Pub. No.: US 2026/0057055 A1
(43) Pub. Date: Feb. 26, 2026

(54) SYSTEM AND METHOD FOR REAL-TIME OPERATOR VERIFICATION IN AIRCRAFT, VEHICLES, AND OTHER TRANSPORTATION MODES

(71) Applicant: Lucky Duck Capital, LLC, Fort Lauderdale, FL (US)

(72) Inventor: Matthew Walter, Boynton Beach, FL (US)

(73) Assignee: Lucky Duck Capital, LLC, Fort Lauderdale, FL (US)

(21) Appl. No.: 19/309,064

(22) Filed: Aug. 25, 2025

Related U.S. Application Data
(60) Provisional application No. 63/686,603, filed on Aug. 23, 2024.

(51) Int. Cl. G06F 21/32; G06V 40/12; G06V 40/16; G06V 40/18

(52) U.S. Cl. CPC G06F 21/32; G06V 40/1365; G06V 40/172; G06V 40/197

(57) ABSTRACT

The invention provides a real-time verification system for operators of aircraft, vehicles, and other modes of transportation for safety and security before commencing travel. The system comprises a processing device installed in the preferred mode of transportation, and includes a processor, memory, and an AI model. The processor integrates modules for receiving biometric data (fingerprint, facial, or retinal scans), verifying identities against a cloud database of operator data and the Terrorist Screening Database (TSDB), and communicating results to Air Traffic Control (ATC). The AI model performs advanced analytics, monitoring verification data against comprehensive databases, and predicting potential issues by analyzing historical trends. It generates detailed reports and alerts for ATC and other authorities, contributing to both immediate safety and long-term improvements. This system ensures that only authorized operators can control the vehicle while fostering ongoing safety enhancements through predictive analytics and trend identification.

### CROSS-REFERENCE TO RELATED APPLICATIONS

This U.S. Non-Provisional Utility patent application claims the benefit of the prior filed U.S. Provisional Patent Application No. 63/686,603, filed Aug. 23, 2024, the entire contents of which are hereby incorporated by reference.

### STATEMENT REGARDING FEDERALLY SPONSORED RESEARCH OR DEVELOPMENT

Not Applicable.

### REFERENCE TO A SEQUENCE LISTING, A LARGE TABLE, OR A COMPUTER PROGRAM LISTING APPENDIX ON READ-ONLY OPTICAL DISC (IF APPLICABLE)

Not Applicable.

### FIELD OF THE INVENTION

This invention generally relates to verifying the identity of human operators of aviation vessels, vehicles, and other similar modes of transportation. More specifically, to real-time verification systems using biometric data to ensure that only authorized and qualified individuals operate such transportation methods.

### BACKGROUND OF THE INVENTION

In today's fast-paced and technologically advanced world, the need for real-time verifications for operators of aircraft, vehicles, and other similar modes of transportation has become increasingly critical. This demand is driven by several key factors such as safety and compliance, security concerns, operational efficiency, technological advancements, market competitiveness, cost savings, etc.

Regulatory bodies, such as the Federal Aviation Administration (FAA) and the Department of Transportation (DOT), mandate strict compliance with safety and operational standards. Real-time verification ensures operators meet these regulations, reducing the risk of accidents and enhancing public safety. Verifying that pilots, drivers, and other operators hold valid licenses, certifications, and other clearances in real-time helps prevent unqualified individuals from operating aircraft or vehicles, thereby mitigating safety risks.

Real-time verification systems can also help prevent unauthorized individuals from accessing and operating aircraft, vehicles, and other modes of transportation. This is particularly important not only in sensitive areas such as airports and secure transportation hubs, but also for transportation routes such as roads, highways, freeways, airways, etc. By implementing real-time checks within the various modes of transportation, anyone can reduce the risk of identity fraud and other security breaches that could lead to severe consequences.

Real-time verification allows for quick and efficient confirmation of operator credentials, minimizing downtime and ensuring that operations run smoothly without unnecessary delays. Automated real-time verification systems can streamline the onboarding and credentialing processes for operators, saving time and reducing administrative burdens.

As aircraft and other vehicles become more technologically sophisticated, integrating real-time verification systems can enhance overall operational management. This includes better coordination of schedules, dispatch, and maintenance routines. Leveraging advanced technologies can ensure the accuracy and reliability of operator verification, thereby boosting trust and confidence in the system.

Offering real-time verification services can enhance customer confidence in aircraft and other vehicle operating companies by demonstrating a commitment to safety and security. Companies that adopt real-time verification systems can differentiate themselves from competitors by showcasing their use of cutting-edge technology and dedication to safety and efficiency.

Automating verification processes can lead to significant cost savings by reducing the need for manual checks and associated labor costs. Ensuring compliance through real-time verifications helps avoid costly fines and penalties associated with regulatory non-compliance.

Furthermore, the need for real-time verifications for operators of aircraft or vehicles is particularly critical in the context of non-commercial aviation and various other modes of transportation, where the human operator plays a crucial role in ensuring safe operations. Despite significant advancements in technology, the transportation industry, especially the non-commercial aviation sector, faces persistent safety challenges. For instance, the U.S. is home to over 230,000 non-commercial aircraft and 630,000 pilots with approximately 1,000 crashes occurring annually, resulting in about 639 fatalities. Alarmingly, 63% of these accidents are attributed to pilot error. This statistic underscores the urgent need for effective measures to verify the qualifications and identity of operators before flight.

Similarly, the need for real-time verifications for operators of aircraft, vehicles, and other modes of transportation is particularly critical in the context of lowering insurance premiums by utilizing artificial intelligence to mitigate risks, predict patterns, and provide insights for future iterations of vehicles.

Existing systems primarily focus on vehicle or aircraft identification through license plates, tail numbers, or transponder signals, without addressing the critical need for verifying the operator's identity and qualifications. This gap leaves room for unauthorized or unqualified individuals to potentially control transportation methods, increasing the risk of accidents and security breaches.

The existing verification technologies, such as those relying on license plates or transponder numbers, are limited in their scope. They do not provide real-time information about the operator's credentials or their compliance with safety regulations. Moreover, the infrequent updates of databases maintained by organizations like the FAA contribute to a lack of timely and accurate verification of operator qualifications.

To fulfill this need in the market, one such invention is disclosed in the prior art as a pilot authentication system (U.S. App. No. US20030068044A1). This prior art discloses a pilot authentication system for both commercial and non-commercial aircraft that uses biometric sensors and a processor to verify authorized pilots and monitor for physical distress. If an unauthorized pilot is detected or if the aircraft is unattended, the system generates and transmits an alert to a ground-based monitoring system, which stores the fingerprint data and notifies law enforcement for further action. The system described has separate components for biometric verification and distress detection, which may not be fully integrated. Further, the disclosed system lacks dynamic or real-time response capabilities beyond generating alerts for manual intervention. As such, this invention in the prior art is severely limited and unable to fulfill all the needs related to an integrated approach to operator authentication, incorporating real-time data verification, cloud-based databases, advanced analytics, and immediate communication with ATC controllers.

There is another invention disclosed in the prior art as an apparatus, system and method for aircraft security and anti-hijacking intervention (U.S. Pat. No. 7,406,368B2). The prior art discloses a security mechanism involving multiple devices for user identification and access control, ensuring only authorized individuals can operate or access the aircraft. It includes monitoring devices that verify user authorization and protocols for remote control in potentially hostile situations to enhance aircraft safety. The method disclosed in the prior art involves multiple steps including biometric data collection, category assignment, and data downloading to both the aircraft and ground-based systems. This complexity could lead to increased resource requirements and operational overhead. The steps of downloading and comparing biometric data, and generating reports could introduce latency, potentially causing delays in access and operational processes, especially in time-critical situations. As such, this invention in the prior art is severely limited and unable to fulfill all the needs related to an integrated approach to operator authentication, incorporating real-time data verification, cloud-based databases, advanced analytics, and immediate communication with ATC controllers.

There is yet another invention disclosed in the prior art as a device for monitoring at least one pilot in a cockpit of an aircraft (U.S. Pat. No. 6,919,808B2). The device disclosed in the prior art features sensory recognition systems for automatic pilot characterization before and during flight. It establishes a reference profile before takeoff and continuously compares it with an actual profile throughout the flight. If discrepancies are detected, a dissimilarity signal is transmitted, triggering an alert to the air traffic control station. The device disclosed in the prior art involves multiple sensory recognition systems and complex information processing modules, potentially increasing the overall cost and complexity of implementation. This complexity may also lead to higher maintenance requirements. Further, real-time comparison of multiple profiles (both reference and actual) and continuous monitoring can put significant processing demands on the device. Ensuring that these comparisons are performed efficiently and without delay could be challenging. As such, this invention in the prior art is severely limited and unable to fulfill all the needs related to an integrated approach to operator authentication, incorporating real-time data verification, cloud-based databases, advanced analytics, and immediate communication with ATC controllers.

There is yet another invention disclosed in the prior art as an aircraft controlled by a secure integrated airspace management system (U.S. App. No. US20210043096A1). The aircraft features an authentication module that stores and transmits a unique pilot ID to a communications module. This module communicates with a secure integrated airspace management (SIAM) system to verify the pilot's authorization, receiving an authorization signal permitting the aircraft's operation if approved. The system can detect and report breaches and unauthorized entries, however it does not seem to offer robust proactive measures to prevent such events, relying instead on post-event alerts and logs. As such, this invention in the prior art is severely limited and unable to fulfill all the needs related to an integrated approach to operator authentication, incorporating real-time data verification, cloud-based databases, advanced analytics, and immediate communication with ATC controllers.

The market need for real-time verifications for operators of aircraft and other vehicles is driven by the imperatives of safety, security, operational efficiency, technological advancements, market competitiveness, and cost savings. As there are no governing laws in regard to operator verification, implementing such systems exceeds the regulatory and safety standards, by positioning the companies at the forefront of innovation, ensuring they remain competitive in an increasingly dynamic and demanding industry.

Accordingly, it is apparent that a need exists for a real-time verification system for operators of aircraft and vehicles for addressing current safety and security challenges and to ensures that operators are verified promptly and accurately, contributing significantly to the reduction of accidents and the enhancement of overall transportation safety.

### BRIEF SUMMARY OF THE INVENTION

The present invention aims to address the issue of unauthorized operation of an aircraft, a vehicle, and other modes of transportation by providing a real-time verification system for operators. The system enhances safety by reducing the number of unlicensed and unauthorized operators. The system includes a processing device installed in the aircraft, vehicle and other modes of transportation that receives biometric data of the operator by presenting an operator app interface on an operator's device. The operator app interface enables the operator to perform a biometric scan including fingerprint, facial, or retinal scan to obtain the biometric data. The verification process includes cross-referencing data with one or more governing bodies or regulatory authorities. Upon successful verification, the results are sent to the one or more governing bodies or other regulatory authorities. These bodies or authorities then authorize the operator to operate the aircraft, vehicle, or other mode of transportation. The system integrates an artificial intelligence (“AI”) model that performs advanced analytics, monitoring verification data against comprehensive databases, and predicting potential issues by analyzing historical trends. It generates detailed reports and alerts for the one or more governing bodies or regulatory authorities, contributing to both immediate safety and long-term improvements. The system ensures that only authorized operators can control the vehicle while fostering ongoing safety enhancements through predictive analytics and trend identification. The system is intended for use on the ground prior to flight to prevent unauthorized individuals, such as minors or non-licensed operators, from utilizing the transportation method.

In one of many other preferred embodiments, the present invention also works seamlessly when operators of autonomous vehicles are remotely authorizing the operation of the autonomous vehicles. The system enhances safety by reducing the number of unlicensed and unauthorized operators of the autonomous vehicles. The system includes a processing device installed in the autonomous vehicle that utilizes autonomous driving authorized by a remote operator. The system receives biometric data of the operator by presenting an operator app interface on an operator's device. The operator app interface enables the operator to perform a biometric scan including fingerprint, facial or retinal scan to obtain the biometric data. The verification process includes cross-referencing data with the one or more governing bodies or other regulatory authorities such as Federal Aviation Administration (“FAA”), as well as security databases such as the Terrorist Screening Database (“TSDB”). Upon successful verification, the results are sent to the one or more governing bodies or other regulatory authorities such as an Air Traffic Control (“ATC”) Controller or other similar controllers, if applicable, who authorize the operator to operate the autonomous vehicle. The system integrates an AI model that performs advanced analytics, monitoring verification data against comprehensive databases, and predicting potential issues by analyzing historical trends. It generates detailed reports and alerts for the one or more governing bodies or other regulatory authorities, contributing to both immediate safety and long-term improvements. The system ensures that only authorized remote operators can control the autonomous vehicle while fostering ongoing safety enhancements through predictive analytics and trend identification. The system is intended for use prior to the functioning of the autonomous vehicle to prevent unauthorized individuals, such as minors or non-licensed operators, from utilizing the transportation method.

According to the first aspect of the invention, a system for real-time verification of an operator of an aircraft, a vehicle, or other mode of transportation before commencing travel is provided. The system includes a processing device configured to receive biometric data of the operator. The biometric data comprises a fingerprint scan, facial scan or a retinal scan of the operator. The processing device verifies the identity of the operator by comparing the biometric data of the operator with operator's data obtained by one or more governing bodies or regulatory authorities. The operator's data comprises personal identifiable information, certifications, licenses associated with the operator. The processing device verifies the identity of the operator by comparing the biometric data of the operator with one or more authoritative databases comprising regulatory, compliance, and security databases maintained by the one or more governing bodies or regulatory authorities. The processing device continuously monitors operator verification data in real-time using an AI model against the one or more authoritative databases and performs predictive analytics using the AI model by comparing current operator verification data with historical trends to determine a likelihood of operator error or a potential security issue. The processing device communicates the verification results and the AI-based analytics to the one or more governing bodies or regulatory authorities. The one or more governing bodies or other regulatory authorities authorize the operator based on the verification results and the AI-based analytics, thereby enabling the operator to operate the aircraft, vehicle, or other mode of transportation.

In one of many preferred embodiments, the processing device is further configured to aggregate analytics data from the real-time monitoring of the operator verification data using the AI model and identify broader trends, including patterns or trends in the operator behavior and system performance based on the aggregated analytics data using the AI model. The patterns and trends as referenced may include detection of operator fatigue or impairment based on deviations in biometric or behavioral data, recognition of repeated unauthorized access attempts by the operator or other individuals, identification of recurrent compliance failures relating to regulatory requirements, or correlation of operator performance with environmental conditions or system load. Consequently, the identified patterns or trends are then used to refine operator training programs, update safety protocols, and inform policy changes for reducing accidents caused by the operator error.

In another one of many preferred embodiments, the refined training programs are dynamically adapted to individual operator profiles, and the policy changes comprise updates to regulatory frameworks for safety.

In yet another one of many preferred embodiments, the biometric data is obtained by presenting an operator app interface on an operator's device. The operator app interface enables the operator to execute the fingerprint scan, facial scan, or retinal scan to obtain the biometric data.

In yet another one of many preferred embodiments, the processing device is further configured to generate detailed reports using the AI model and to provide alerts to the one or more governing bodies or regulatory authorities. The reports and alerts comprise actionable insights to enhance decision-making.

In yet another one of many preferred embodiments, the AI model is trained using a plurality of heterogeneous datasets comprising biometric data, historical operational records, security database information, operator behavioral data, and environmental data, thereby enabling the AI model to perform adaptive verification and the predictive analytics under varying operational conditions.

In yet another one of many preferred embodiments, the verification process complies with the privacy and security guidelines outlined in the related Privacy Impact Assessment (ALL/PIA-027).

In yet another one of many preferred embodiments, the system is installed in the aircraft, vehicle, or other mode of transportation.

In yet another one of many preferred embodiments, the vehicle is an autonomous vehicle that utilizes autonomous driving authorized by a remote operator.

According to the second aspect of the invention, a system for real-time verification of an operator of an aircraft, a vehicle, or other mode of transportation before commencing travel is provided. The system includes a processing device installed in the aircraft, vehicle, or other mode of transportation. The processing device is configured to receive biometric data of the operator by presenting an operator app interface on an operator's device. The operator app interface enables the operator to execute a fingerprint scan, facial scan, or retinal scan to obtain the biometric data. The processing device verifies the identity of the operator by comparing the biometric data of the operator with operator's data obtained by one or more governing bodies or regulatory authorities. The operator's data comprises personal identifiable information, certifications, licenses associated with the operator. The processing device verifies the identity of the operator by comparing the biometric data of the operator with one or more authoritative databases comprising regulatory, compliance, and security databases maintained by the one or more governing bodies or regulatory authorities. The processing device continuously monitors operator verification data in real-time using an AI model against the one or more authoritative databases. The processing device performs predictive analytics using the AI model by comparing current operator verification data with historical trends to determine a likelihood of operator error or a potential security issue. The processing device identifies broader trends, including patterns or trends in operator behavior and system performance based on an aggregated analytics data using the AI model. The patterns and trends as referenced may include detection of operator fatigue or impairment based on deviations in biometric or behavioral data, recognition of repeated unauthorized access attempts by the operator or other individuals, identification of recurrent compliance failures relating to regulatory requirements, or correlation of operator performance with environmental conditions or system load. Consequently, the identified patterns or trends are then used to refine operator training programs, update safety protocols, and inform policy changes for reducing accidents caused by the operator error.

The processing device communicates or transmits the verification results and the AI-based analytics to the one or more governing bodies or regulatory authorities. Based on the verification results and the AI-based analytics, the governing bodies or other regulatory authorities authorize the operator, thereby enabling the operator to operate an aircraft, vehicle, or other mode of transportation.

In one of many preferred embodiments, the analytics data is aggregated from the real-time monitoring of the operator verification data using the AI model.

In another one of many preferred embodiments, the refined training programs are dynamically adapted to individual operator profiles, and the policy changes comprise updates to regulatory frameworks for safety.

In yet another one of many preferred embodiments, the processing device is further configured to generate detailed reports using the AI model and to provide alerts to the one or more governing bodies or regulatory authorities. The reports and alerts comprise actionable insights to enhance decision-making.

In yet another one of many preferred embodiments, the AI model is trained using a plurality of heterogeneous datasets comprising biometric data, historical operational records, security database information, operator behavioral data, and environmental data, thereby enabling the AI model to perform adaptive verification and the predictive analytics under varying operational conditions.

In yet another one of many preferred embodiments, the verification process complies with the privacy and security guidelines outlined in the related Privacy Impact Assessment (ALL/PIA-027).

In yet another one of many preferred embodiments, the vehicle is an autonomous vehicle that utilizes autonomous driving authorized by a remote operator.

According to the third aspect of the invention, a method for performing real-time verification of an operator of an aircraft, a vehicle, or other mode of transportation before commencing travel is provided. The method includes receiving biometric data of the operator by a processing device. The biometric data comprises a fingerprint scan, facial scan or a retinal scan of the operator. The method includes verifying the identity of the operator by the processing device, by comparing the biometric data of the operator with operator's data obtained by one or more governing bodies or regulatory authorities. The operator's data comprises personal identifiable information, certifications, licenses associated with the operator. The method includes verifying the identity of the operator by the processing device, by comparing the biometric data of the operator with one or more authoritative databases comprising regulatory, compliance, and security databases maintained by the one or more governing bodies or regulatory authorities. The method includes continuously monitoring operator verification data in real-time by the processing device using an AI model against the one or more authoritative databases. The method includes performing predictive analytics by the processing device using the AI model by comparing current operator verification data with historical trends to determine a likelihood of operator error or a potential security issue. The method includes communicating the verification results and the AI-based analytics by the processing device to the one or more governing bodies or regulatory authorities. The governing bodies or other regulatory authorities authorize the operator based on the verification results and the AI-based analytics, thereby enabling the operator to operate the aircraft, vehicle, or other mode of transportation.

In one of many preferred embodiments, the method further comprises aggregating analytics data from the real-time monitoring of operator verification data using the AI model, and identifying broader trends, including patterns or trends in the operator behavior and system performance based on the aggregated analytics data using the AI model. The identified trends are used to refine operator training programs, update safety protocols, and inform policy changes for reducing accidents caused by the operator error.

In another one of many preferred embodiments, the refined training programs are dynamically adapted to individual operator profiles, and the policy changes comprise updates to regulatory frameworks for safety.

In yet another one of many preferred embodiments, the biometric data is obtained by presenting an operator app interface on an operator's device. The operator app interface enables the operator to execute the fingerprint scan, facial scan, or retinal scan to obtain the biometric data.

The embodiments covered by this patent are defined by the claims. The summary above provides a general overview of various aspects and introduces some of the concepts that are discussed in greater detail in the following description section. This summary is not meant to identify the key or essential features of the claimed subject matter, nor is it intended to be used on its own to determine the scope of the claims. The subject matter should be understood with reference to the entire specification, including any relevant drawings and the claims themselves.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

FIG. 1 illustrates a system for real-time verification of an operator of an aircraft, a vehicle, or other mode of transportation before commencing travel according to various embodiments of the present invention.

FIG. 2 illustrates the processor hosting the AI model of FIG. 1 according to various embodiments of the present invention.

FIG. 3 illustrates a workflow of the system of FIG. 1 for real-time verification of the operator of the aircraft, vehicle, or other mode of transportation before commencing the travel according to various embodiments of the present invention.

FIGS. 4A-B are flow diagrams that illustrate a method for real-time verification of an operator of an aircraft, a vehicle, or other mode of transportation before commencing travel according to various embodiments of the present invention.

FIG. 5 illustrates a general computer architecture that can be appropriately configured to implement components disclosed in accordance with various embodiments of the present invention.

Like reference numerals refer to like parts throughout the several views of the drawings.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular form “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion.

Nevertheless, the specification and claims should be read with the understanding that such combinations are entirely within the scope of the invention and the claims. System and method for real-time operator verification in aircraft, vehicles, and other transportation modes is discussed herein. In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention and is not intended to limit the invention to the specific embodiments illustrated by the figures or description below. The present invention will now be described by referencing the appended figures representing preferred embodiments.

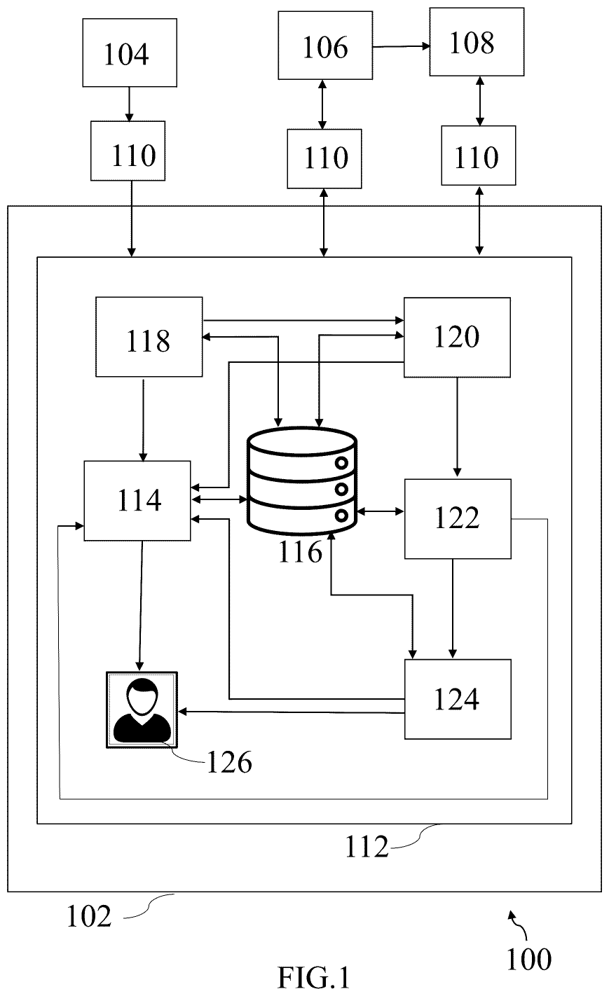

FIG. 1 illustrates a system for real-time verification of an operator of an aircraft, a vehicle, or other mode of transportation before commencing travel according to various embodiments of the present invention. The system 100 includes a processing device 102, an operator's device 104, a cloud database 106 and an authoritative Database 108, a communication network 110. The processing device 102 comprises a processor 112 and a memory communicably connected to the processor 112. The processing device 102 is installed in the aircraft, vehicle, or other mode of transportation. The processor 112 includes a plurality of modules and an AI model 114 stored in a database 116 to perform the real-time identification and verification of the operator of the aircraft, vehicle, or other mode of transportation before commencing the travel. The cloud database 106 stores the operator's data currently obtained by one or more governing bodies or regulatory authorities, for example Federal Aviation Administration (FAA). The operator's data may include personal identifiable information, certifications, licenses associated with the operator.

FIG. 1 further illustrates the plurality of modules of the processor 112 including a biometric data receiving module 118 configured to receive the biometric data of the operator by presenting an operator app interface on the operator's device 104. The biometric data includes a fingerprint scan, facial scan or a retinal scan of the operator. The operator app interface enables the operator to execute the fingerprint scan, facial scan, or the retinal scan. The plurality of modules of the processor 112 includes a first verification module 120 configured to verify the identity of the operator by comparing the biometric data of the operator with the operator's data obtained by one or more governing bodies or regulatory authorities. The operator's data may be stored in the cloud database 106. The plurality of modules of the processor 112 includes a second verification module 122 configured to verify the identity of the operator by comparing the biometric data of the operator with one or more authoritative databases comprising regulatory, compliance, and security databases maintained by the one or more governing bodies or regulatory authorities. The authoritative database 108 may be a Terrorist Screening Database (TSDB) maintained by Federal Bureau of Investigation (FBI) and Department of Homeland Security (DHS). This verification process adheres to the privacy and security guidelines outlined in the related Privacy Impact Assessment (ALL/PIA-027). The AI model 114 is configured to continuously monitor operator verification data in real-time against the one or more authoritative databases. The AI model 114 is configured to perform predictive analytics by comparing current operator verification data with historical trends to determine a likelihood of operator error or a potential security issue. The AI model 114 continuously monitors the operator's verification data against a comprehensive database, including the TSDB and other security databases maintained by the FBI, DHS and other relevant agencies. The AI model 114 performs the predictive analytics to foresee potential issues, such as the likelihood of the operator error, by comparing current data with historical trends. Furthermore, the AI model 114 generates detailed reports and alerts for the one or more governing bodies or other regulatory authorities 126 and other relevant authorities, providing actionable insights to enhance decision-making.

The plurality of modules of the processor 112 includes a communication module 124 configured to communicate the verification results to the one or more governing bodies or regulatory authorities. The one or more governing bodies or other regulatory authorities 126 authorize the operator based on the verification results and the AI-based analytics, thereby enabling the operator to operate the aircraft, vehicle, or other mode of transportation. The one or more governing bodies or other regulatory authorities 126 may be an Air Traffic Control Controller (ATC). The ATC controller evaluates the verification results and the AI-based analytics in real-time and issues authorization clearance for the operator to commence, continue, or terminate a flight operation in accordance with established safety protocols. For instance, the operator may be a pilot, and the aircraft may be non-commercial aircraft.

In addition to real-time monitoring, the AI model 114 contributes to long-term safety improvements by compiling analytics data to identify broader trends, including patterns or trends operator behavior and system performance. These insights can be used to refine training programs, update safety protocols, and inform policy changes aimed at reducing the incidence of accidents caused by operator's error. By leveraging the power of AI, the system 100 not only ensures immediate safety and security but also fosters a proactive approach to continuous safety enhancement in non-commercial aviation and other transportation methods. The AI model 114 dynamically adapts training programs to individual operator profiles, tailoring content based on performance, behavior, and historical data. In parallel, the system informs policy changes by identifying systemic patterns and recommending updates to regulatory frameworks for safety, thereby ensuring that both individual operators and broader organizational standards evolve in response to emerging risks and operational insights.

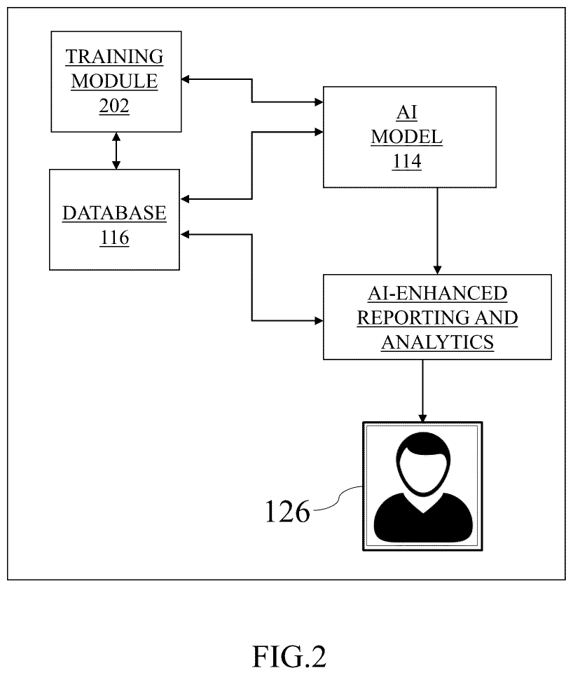

FIG. 2 illustrates the processor hosting the AI model of FIG. 1 according to various embodiments of the present invention. The AI model 114 is trained using the training module 202. The database 116 stores the attributes for training the AI model 114. The AI model 114 utilizes advanced artificial intelligence algorithms to analyze real-time data collected from the verification processes, including biometric scans (fingerprint, retinal, facial recognition) and other relevant inputs. By processing this data, the AI model 114 can identify patterns and anomalies that may indicate potential safety risks or unauthorized access attempts. The attributes used for training the AI model 114 encompass a range of critical data types to ensure robust performance and accuracy. Biometric data including attributes from fingerprint, retinal, and facial recognition scans help the AI model 114 differentiate between authorized and unauthorized individuals based on their unique biometric identifiers. Historical data from previous verification processes and operator behavior patterns equips the AI model 114 to detect anomalies and potential safety risks by learning from past incidents. Security database information from sources such as the TSDB and FAA records ensures that the AI model 114 aligns with current security standards and effectively identifies known threats. Operational data related to the aircraft or vehicle's status and system functionality aids in monitoring the system's performance and detecting any deviations. Behavioral data on operator performance, including reaction times and adherence to safety protocols, further enhances the model's ability to assess risk. Lastly, environmental data, such as lighting conditions and weather impacts, ensures that the AI model 114 adapts to varying operational conditions. Collectively, these attributes enable the AI model 114 to develop a nuanced understanding of normal versus abnormal behavior, thus improving its capacity to identify potential risks and unauthorized access attempts with high accuracy.

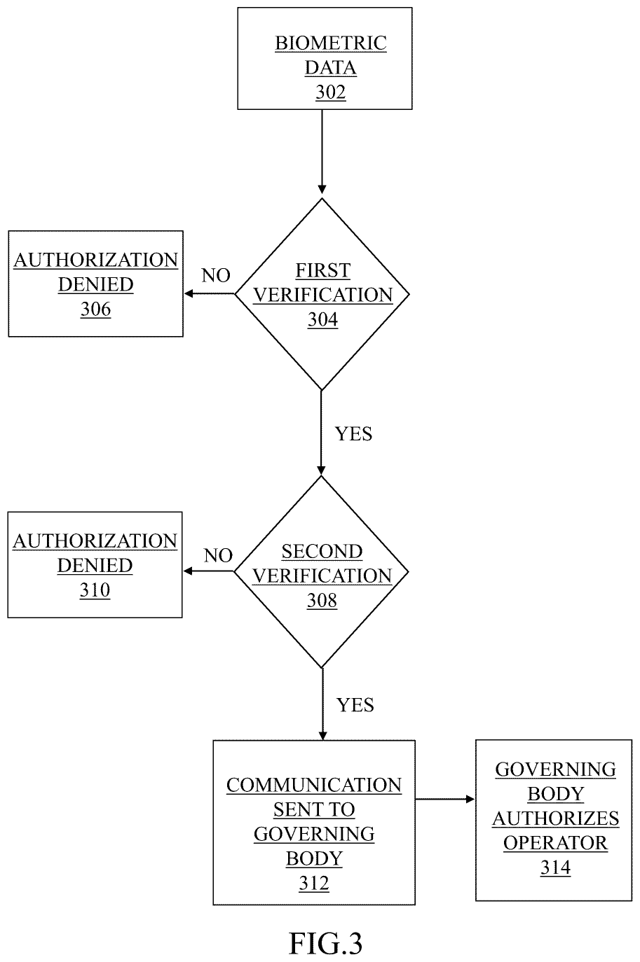

FIG. 3 illustrates a workflow of the system of FIG. 1 for real-time verification of the operator of the aircraft, vehicle, or other mode of transportation before commencing the travel according to various embodiments of the present invention. At step 302, the biometric data of the operator, including the fingerprint scan, facial scan or the retinal scan is obtained. At step 304, a first verification is performed by comparing the biometric data of the operator with the operator's data obtained by one or more governing bodies or regulatory authorities. At step 306, the authorization is denied if the first verification fails, thereby preventing the operator from operating the aircraft, vehicle, or other mode of transportation. At step 308, a second verification is performed by comparing the biometric data of the operator with one or more authoritative databases comprising regulatory, compliance, and security databases maintained by the one or more governing bodies or regulatory authorities, on successful first verification. At step 310, the authorization is denied if the second verification fails, thereby preventing the operator from operating the aircraft, vehicle, or other mode of transportation. At step 312, a communication is sent to the one or more governing bodies or regulatory authorities on successful second verification. At step 314, the one or more governing bodies or regulatory authorities 126 authorize the operator enabling the operator to operate the aircraft, vehicle, or other mode of transportation.

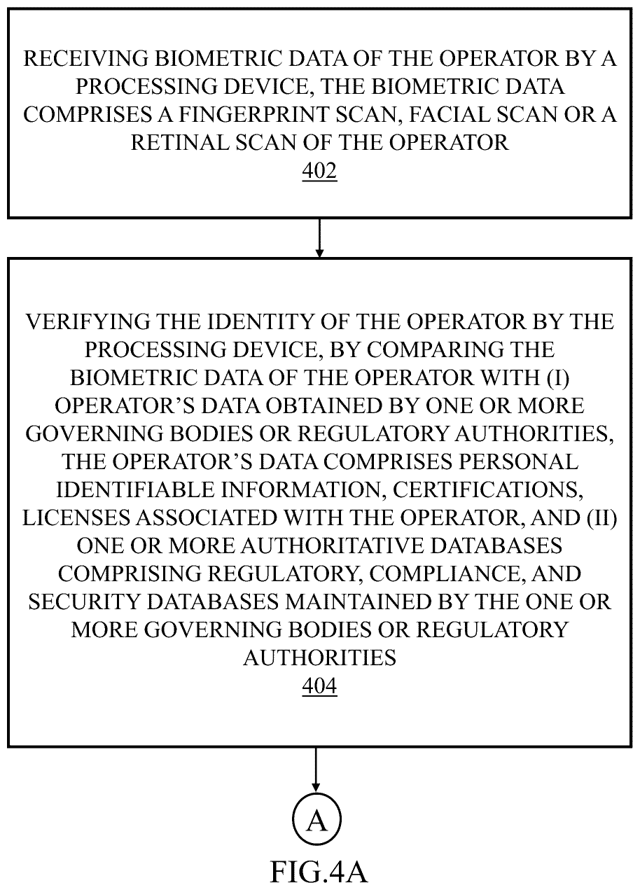

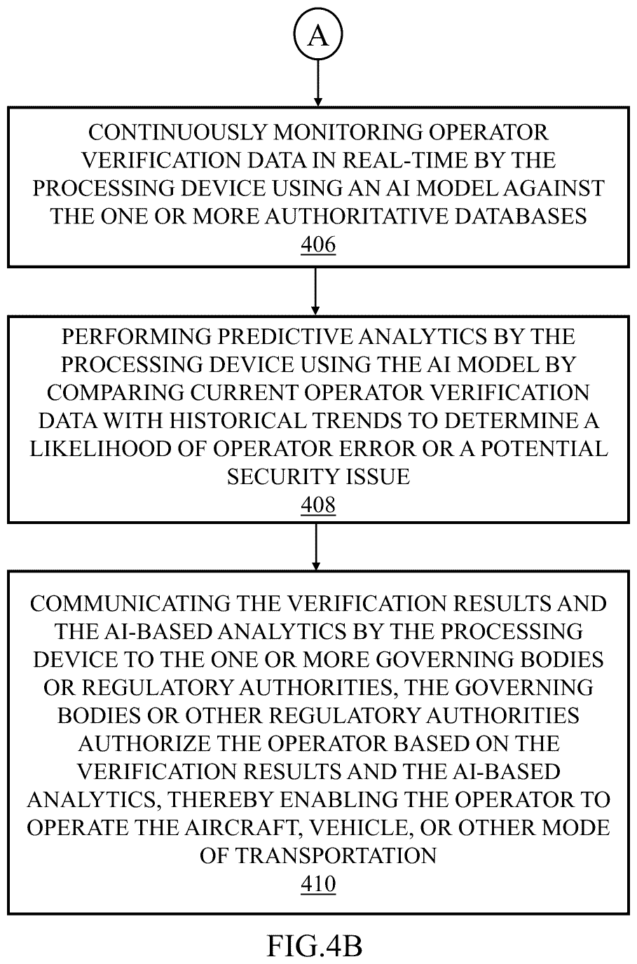

FIGS. 4A-B are flow diagrams that illustrate a method for real-time verification of an operator of an aircraft, a vehicle, or other mode of transportation before commencing travel according to various embodiments of the present invention.

The method includes at step 402, receiving biometric data of the operator by a processing device. The biometric data comprises a fingerprint scan, facial scan or a retinal scan of the operator.

The method includes at step 404, verifying the identity of the operator by the processing device, by comparing the biometric data of the operator with (i) operator's data obtained by one or more governing bodies or regulatory authorities, the operator's data comprises personal identifiable information, certifications, licenses associated with the operator, and (ii) one or more authoritative databases comprising regulatory, compliance, and security databases maintained by the one or more governing bodies or regulatory authorities.

The method includes at step 406, continuously monitoring operator verification data in real-time by the processing device using an AI model against the one or more authoritative databases.

The method includes at step 408, performing predictive analytics by the processing device using the AI model by comparing current operator verification data with historical trends to determine a likelihood of operator error or a potential security issue.

The method includes at step 410, communicating the verification results and the AI-based analytics by the processing device to the one or more governing bodies or regulatory authorities. The governing bodies or other regulatory authorities authorize the operator based on the verification results and the AI-based analytics, thereby enabling the operator to operate the aircraft, vehicle, or other mode of transportation.

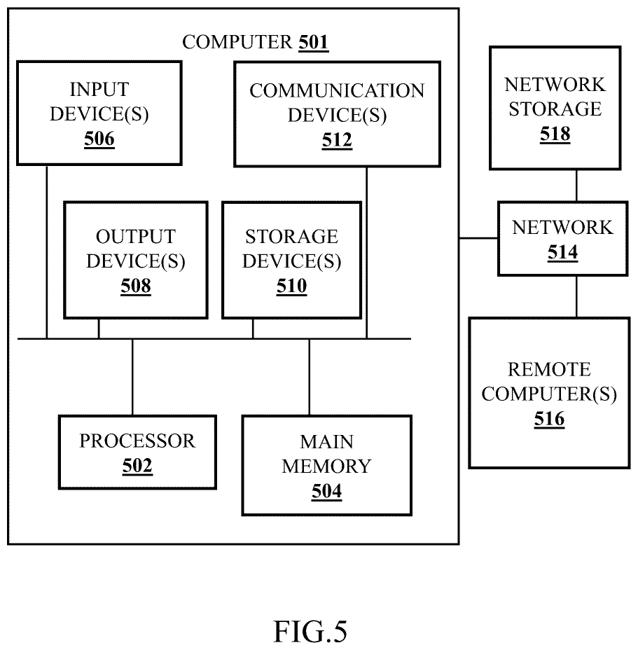

FIG. 5 illustrates a general computer architecture that can be appropriately configured to implement components disclosed in accordance with various embodiments of the present disclosure. The general computing architecture 500 can include various common computing elements, such as a computer 501, a network 514, and one or more remote computers 516. The computer 501 may be a server, a desktop computer, a laptop computer, a tablet computer, or a mobile computing device. The computer 501 may include a processor 502, a main memory 504 and a system bus. The processor 502 may feature one or more processing units that can operate independently of each other. The main memory 504 may include volatile devices, non-volatile devices, or other random access memory devices. The computer 501 may feature secondary storage 510, consisting of one or more removable and/or non-removable storage units. These units house an operating system that manages various applications on the computer 501. The secondary storage 510 may also be used to store software configured to implement the components of the embodiments disclosed herein, which may be executed as one or more applications under the operating system. The computer 501 may also include a communication device(s) 512 through which the computer communicates with other devices, such as one or more remote computers 516, over wired and/or wireless computer networks 514. The communication device(s) 512 may communicate over but not limited to Wi-Fi, Bluetooth, ultra-wide band technology, and mobile telephone networks. The computer 501 may also access network storage 518 through computer network 514. The network storage 518 may include a network-attached storage device or cloud-based storage. The operating system and/or software may be stored in network storage 518. The computer 501 may have various input device(s) 506 for example, keyboard, mouse, touchscreen, camera, microphone, or a sensor, output device(s) 508, for example, a display, speakers, or a printer. Storage devices 510, the communication device(s) 512, input devices 506 and output devices 508 may be integrated within a computer system or connected through various computer input/output interface devices.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

What is claimed is:

1. A system for real-time verification of an operator of an aircraft, a vehicle, or other mode of transportation before commencing travel, wherein the system comprising:
a processing device including a processor and a memory storing instructions operable by the processing device that, when executed by the processor, causing the processing device to:
receive biometric data of the operator, wherein the biometric data comprising at least one of a fingerprint scan, a facial scan or a retinal scan of the operator;
verify the identity of the operator by comparing the biometric data of the operator with (i) the operator's data obtained by one or more governing bodies or regulatory authorities, wherein the operator's data including personal identifiable information, certifications, and licenses associated with the operator, and (ii) one or more authoritative databases including regulatory, compliance, and security databases maintained by one or more governing bodies or regulatory authorities;
continuously monitor operator verification data in real-time using an AI model against one or more authoritative databases;
perform predictive analytics using the AI model by comparing current operator verification data with historical trends to determine a likelihood of operator error or a potential security issue; and
communicate the verification results and the predictive analytics to one or more governing bodies or regulatory authorities for authorization of the operator.

2. The system of claim 1, wherein the processing device is further configured to:
(i) aggregate analytics data generated during the real-time monitoring of the operator verification data using the AI model; and
(ii) identify patterns or trends in the operator behavior and system performance based on the aggregated analytics data using the AI model, wherein the identified trends or patterns are used to refine operator training programs, update safety protocols, and inform policy changes for reducing accidents caused by the operator error.

3. The system of claim 2, wherein the refined training programs are dynamically adapted to individual operator profiles, wherein the policy changes comprise updates to regulatory frameworks for safety.

4. The system of claim 1, wherein the biometric data is obtained by presenting an operator app interface on an operator's device, wherein the operator app interface enables the operator to execute the fingerprint scan, facial scan, or retinal scan to obtain the biometric data.

5. The system of claim 1, wherein the processing device is further configured to generate detailed reports using the AI model and to provide alerts to the one or more governing bodies or regulatory authorities, wherein the reports and alerts comprise actionable insights to enhance decision-making.

6. The system of claim 1, wherein the AI model is trained using a plurality of heterogeneous datasets comprising biometric data, historical operational records, security database information, operator behavioral data, and environmental data, thereby enabling the AI model to perform adaptive verification and the predictive analytics under varying operational conditions.

7. The system of claim 1, wherein the verification process complies with the privacy and security guidelines outlined in the related Privacy Impact Assessment (ALL/PIA-027).

8. The system of claim 1, wherein the system is installed in the aircraft, vehicle, or other mode of transportation.

9. The system of claim 1, wherein the vehicle is an autonomous vehicle that utilizes autonomous driving authorized by a remote operator.

10. A system for real-time verification of an operator of an aircraft, a vehicle, or other mode of transportation before commencing travel, wherein the system comprising:
a processing device installed in the aircraft, vehicle, or other mode of transportation comprising a processor and a memory storing instructions operable by the processing device that, when executed by the processor, cause the processing device to:
receive biometric data of the operator by presenting an operator app interface on an operator's device, wherein the operator app interface enabling the operator to execute a fingerprint scan, facial scan, or retinal scan to obtain the biometric data;
verify the identity of the operator by comparing the biometric data of the operator with (i) operator's data obtained by one or more governing bodies or regulatory authorities, wherein the operator's data comprising personal identifiable information, certifications, licenses associated with the operator, and (ii) one or more authoritative databases comprising regulatory, compliance, and security databases maintained by the one or more governing bodies or regulatory authorities;
continuously monitor operator verification data in real-time using an AI model against the one or more authoritative databases;
perform predictive analytics using the AI model by comparing current operator verification data with historical trends to determine a likelihood of operator error or a potential security issue;
identify patterns or trends in the operator behavior and system performance based on an aggregated analytics data using the AI model, wherein the identified patterns or trends are used to refine operator training programs, update safety protocols, and inform policy changes for reducing accidents caused by the operator error; and
communicate the verification results and the predictive analytics to one or more governing bodies or regulatory authorities for authorization of the operator.

11. The system of claim 10, wherein the analytics data is aggregated from the real-time monitoring of the operator verification data using the AI model.

12. The system of claim 10, wherein the refined training programs are dynamically adapted to individual operator profiles, wherein the policy changes comprise updates to regulatory frameworks for safety.

13. The system of claim 10, wherein the processing device is further configured to generate detailed reports using the AI model and to provide alerts to the one or more governing bodies or regulatory authorities, wherein the reports and alerts comprise actionable insights to enhance decision-making.

14. The system of claim 10, wherein the AI model is trained using a plurality of heterogeneous datasets comprising biometric data, historical operational records, security database information, operator behavioral data, and environmental data, thereby enabling the AI model to perform adaptive verification and the predictive analytics under varying operational conditions.

15. The system of claim 10, wherein the verification process complies with the privacy and security guidelines outlined in the related Privacy Impact Assessment (ALL/PIA-027).

16. The system of claim 10, wherein the vehicle is an autonomous vehicle that utilizes autonomous driving authorized by a remote operator.

17. A method for performing real-time verification of an operator of an aircraft, a vehicle, or other mode of transportation before commencing travel, wherein the method comprising:
receiving biometric data of the operator by a processing device, wherein the biometric data including a fingerprint scan, facial scan or a retinal scan of the operator;
verifying the identity of the operator by the processing device, by comparing the biometric data of the operator with (i) operator's data obtained by one or more governing bodies or regulatory authorities, wherein the operator's data including personal identifiable information, certifications, licenses associated with the operator, and (ii) one or more authoritative databases comprising regulatory, compliance, and security databases maintained by the one or more governing bodies or regulatory authorities;
continuously monitoring operator verification data in real-time by the processing device using an AI model against the one or more authoritative databases;
performing predictive analytics by the processing device using the AI model by comparing current operator verification data with historical trends to determine a likelihood of operator error or a potential security issue; and
communicating the verification results and the AI-based analytics by the processing device to one or more governing bodies or regulatory authorities, wherein the governing bodies or other regulatory authorities authorizing the operator to operate the aircraft, vehicle, or other mode of transportation based on the verification results and the AI-based analytics.

18. The method of claim 17, wherein the method further comprising:
(i) aggregating analytics data from the real-time monitoring of operator verification data using the AI model; and
(ii) identifying patterns or trends in the operator behavior and system performance based on the aggregated analytics data using the AI model, wherein the identified trends are used to refine operator training programs, update safety protocols, and inform policy changes for reducing accidents caused by the operator error.

19. The method of claim 18, wherein the refined training programs are dynamically adapted to individual operator profiles, wherein the policy changes comprise updates to regulatory frameworks for safety.

20. The method of claim 17, wherein the biometric data is obtained by presenting an operator app interface on an operator's device, wherein the operator app interface enables the operator to execute the fingerprint scan, facial scan, or retinal scan to obtain the biometric data.
